(19) United States
(12) Patent Application Publication
(10) Pub. No.: US 2014/0278761 A1
(43) Pub. Date: Sep. 18, 2014

(54) METHOD AND APPARATUS FOR DATA MATCHING AND INTEGRATION

(71) Applicant: BRIGHTTAG INC., Chicago, IL (US)

(72) Inventors: Eric M. LUNT, Barrington, IL (US); Blane E. SIMS, Chicago, IL (US); Marc E. KIVEN, Buffalo Grove, IL (US); Michael D. SANDS, Chicago, IL (US)

(73) Assignee: BRIGHTTAG INC., Chicago, IL (US)

(21) Appl. No.: 14/213,228

(22) Filed: Mar. 14, 2014

Related U.S. Application Data
(60) Provisional application No. 61/792,491, filed on Mar. 15, 2013.

(51) Int. Cl. G06Q 30/02

(52) U.S. Cl. CPC G06Q 30/0201
USPC 705/7.29

(57) ABSTRACT

Certain embodiments generally relate to data matching, such as, but not limited to systems, methods, apparatuses and computer program products for data matching and integration. For example, the method may include receiving data from a plurality of delivery channels in any channel. The method may also include matching cross-device user identifiers and profiles in near real-time. The method may further include synchronizing the received data in near real-time by server-to-server direct messaging to a plurality of integrated services.

### CROSS-REFERENCE TO RELATED APPLICATION

This application is related to and claims the priority of U.S. Provisional Patent Application No. 61/792,491, which was filed Mar. 15, 2013, and which is hereby incorporated herein by reference in its entirety.

### BACKGROUND

1. Field

Certain embodiments generally relate to a method and apparatus for data matching and integration.

2. Description of the Related Art

Consumers interact with brands and stores across various channels and devices. Marketing channels may include broadcast media, direct mail, email, web media, mobile media, out-of-home media, point-of-sale media, etc. Purchasing channels may include brick-and-mortar stores, catalog and call center sales, Internet and mobile device sales, etc. Devices may include a number of cross-devices, such as, web browsers; native applications running on desktop computers or mobile phones/tablets; embedded applications within devices such as Point-of-Sale systems, televisions/set-top boxes/gaming consoles, appliances, vehicle informatics, network routing equipment, etc. Brands and stores also leverage data warehouses and marketing service providers to aggregate data from the various channels and devices on which interactions and purchases take place. There are digital shoppers who are multi-channel buyers who research products/services in more than one channel or device. These shoppers also make purchases online and offline. There are researchers who purchase products/services offline and research online. And there are holdouts that have not researched or bought online

Smartphone owners make real-time buying decisions with their devices by scanning barcodes, comparing product prices, finding store locations, searching for coupons, and researching products.

Currently online marketing utilizes primarily tags as a way to connect what clients are doing online, but consumers do not just live online. Both tags and cookies exist on the web, online and cannot be linked across channels, such as, mobile devices, ads, stores, email, call centers, social networks, and analytics. Commercial webpages include code that makes web server requests specifically for the purpose of recording marketing and user interaction events for subsequent analysis. Tags are commonly referred to as a tracking tag, this code is interpreted by a user's web browser as part of the instruction set for rendering and controlling the behavior of a webpage.

Examples of the data analysis made possible by tracking tags include, but are not limited to: the geographic location of the user, the number of times a webpage has been viewed by a unique user, the links on a page that a user has clicked, the ads that were included on a page, whether the user accessed a page in response to an ad or marketing campaign, and how much money a user spent on a website after responding to a particular campaign, etc.

There is a need to collect, match and integrate data where tags and cookies do not exist and doing so in real-time or near real-time across multiple channels may create a unified customer experience across these channels to drive engagement, purchasing and loyalty.

### SUMMARY

According to a first embodiment, a method may be provided for data matching and integration. The method may include receiving data from a plurality of delivery channels. The method may also include matching cross-device user identifiers and profiles in near real-time. The method may further include synchronizing the received data in near real-time via server-to-server direct messaging to a plurality of integrated services.

According to a second embodiment, an apparatus may be provided for data matching and integration. The apparatus may include at least one processor and at least one memory including computer program code. The at least one memory and the computer program code may be configured to, with the at least one processor, cause the apparatus at least to receive data from a plurality of delivery channels. The at least one memory and the computer program code may be configured to, with the at least one processor, cause the apparatus at least to then match cross-device user identifiers and profiles in near real-time. The at least one memory and the computer program code may be configured to, with the at least one processor, cause the apparatus at least to then synchronize the received data in near real-time via server-to-server direct messaging to a plurality of integrated services.

According to a third embodiment, a system may be provided for data matching and integration. The system may include at least one Internet-connected device. The system may also include at least one virtual local area network (VLAN). The system may further include the apparatus of the second embodiment discussed above, such that, the at least one memory and the computer program code may be configured to, with the at least one processor, cause the apparatus at least to receive data, via the VLAN, from a plurality of delivery channels. The at least one memory and the computer program code may be configured to, with the at least one processor, cause the apparatus at least to then match, via the VLAN, cross-device user identifiers and profiles in near real-time. The at least one memory and the computer program code may be configured to, with the at least one processor, cause the apparatus at least to then synchronize, via the VLAN, the received data in near real-time via server-to-server direct messaging to a plurality of integrated services.

According to a fourth embodiment, a computer program product may store a program having software code portions being configured, when run on a processor, to perform the method according to the first embodiment discussed above.

### BRIEF DESCRIPTION OF THE DRAWINGS

For proper understanding of the invention, reference should be made to the accompanying drawings, wherein:

FIG. 1 illustrates system components and integration process flow chart according to certain embodiments.

FIG. 2 illustrates multiparty identifier synchronization process flow chart according to certain embodiments.

FIG. 3 illustrates identifier matching process flow chart according to certain embodiments.

FIG. 4 illustrates a block diagram of a system according to certain embodiments.

### DETAILED DESCRIPTION

Certain embodiments show Internet-connected devices which may include, for example, the following: web browsers; native applications running on desktop computers or mobile phones/tablets; embedded applications within devices such as Point-of-Sale systems, televisions/set-top boxes/gaming consoles, appliances, vehicle informatics, network routing equipment, etc.; and scripting language calls and other programming interfaces to operating system internals and extensions that initiate connections to a foreign host using Internet protocols that include HTTP, HTTPS and TCP/IP. These devices, along with their individual user identifiers and user profiles, may be referred to as cross-devices. A user profile may be, for example, a user's location, name, favorites, etc. A user identifier may be, for example, a coded identifier usually an integer value associated with each particular user.

FIG. 1 illustrates system components and an integration process flow 100 according to certain embodiments. In one embodiment, a data receiver application programming interface (API) may be called by an application executing within an Internet-connected device 110 when a user identifier is available for synchronization and/or a user action of interest takes place on the Internet-connected device 110.

In some embodiments the data receiver API 1 may contact an identifier sync service 3 for identifier synchronization or a data listener service 5 when a user action takes place. One or more Hypertext Transfer Protocol (HTTP) load balancer hardware or virtual machine 2 may be used to distribute API requests across multiple instances of each of the services. In its request to identifier sync service 3, the data receiver API 1 may be configured to provide one or more identifiers for an Internet-connected device 110 or user.

Identifiers may include, for example, the following: values stored in web browser cookies; identifiers provided by the device operating system; identifiers provided by a third-party; and user-provided identifiers or derivatives thereof such as email address, phone number, loyalty program ID, credit card number, address, etc.

Upon receiving an Internet-connected device 110 or user identifier, identifier sync service 3 may create or modify a record in an identifier database 4 using a multiparty identifier synchronization module, as outlined in FIG. 2.

In its request to the data listener service 5, data receiver API 1 may reference at least one identifier for each Internet-connected device 110 or user and may provide user action data to be received by HTTP load balancer 2.

User action data may consist of the source of the data, such as, integration service client ID or user agent type, name of the action that took place and all related metadata to that action. For example, if user ID 123455 purchased a product at a point of sale system belonging to “BigBox Stores,” the API call may include: Integration Service Client ID: ABCDEFG and User Agent: BigBox Stores POS. In another example, the data may include the following; user ID: BigBox Customer Email Hash=a6d89f30691ae55ca65e5f06ca9fc03d; Action: Purchase; Metadata: Timestamp=2012-12-01-17:55:00GMT, Store ID=12345; Store Latitude=41.890237, Store Longitude=−87.634434, Currency=USD, Cart Total=1349.95, Products Purchased Array: Category=HDTV,SKU=05775592000P, Name=“Panasonic 50” 3D Plasma HDTV”,Price=1300.00; and Category=TV Accessories, SKU=05750117000P,Name=“Monster HDMI Cable”,Price=49.95.

In these example cases, upon receiving a request from the data receiver API 1, via the HTTP Load Balancer 2, the data listener service 5 may contact the data dispatcher service 6. Data dispatcher service 6 may look up routing data routing rules for the request from an integration rules database 7 using the integration service client ID and action name provided in the data receiver API 1 call as lookup keys. Integration rules database 7 may describe an integrated service 13 that is configured to receive the data and the business rules that may be used by data transformation service 8. Integrated service 13 may include a plurality of integrated services, for example, digital analytics, desktop and mobile Ad networks, search marketing, email marketing, vendor services, etc.

In other examples, the integration rules database 7 may include the following: Integration Service Client ID: ABCDEFG; User Agent: BigBox Stores POS; Action: Purchase; Destinations: “Ad Network A”, “Email Service B”. In this example, the Integration Service Client ID (ie., ABCDEFG), the User Agent (i.e., BigBox Stores POS), and the Action (i.e., Purchase) is associated with two particular Destinations (i.e., Ad Network A and Email Service B).

In another example, transformation rules of the data transformation service 8 may include the following: “Ad Network A”—Send data only if Cart Total>500, Set Advertiser ID to 99999, Set Segment ID to 23456, Add to ““Ad Network A” Segment Update” Data Distribution Queue, Lookup “Ad Network A” 3^{rd} Party Cookie ID using BigBox Customer Email Hash as key, API format=“GET http://s.adnetworka.com/add?adv=Advertiser ID&seg=Segment ID, Cookie:adnetId=“Ad Network A” 3^{rd} Party Cookie ID”.

In yet another example, “Email Service B” may include the following: Set Email type to “Cross-sell”, Set Order Total to the next highest whole number based on Cart Total, Set Product Name, Image URL and Recommended Products Array by looking up SKU=05775592000P using Baynote Recommendations Plugin, Add to ““Email Service B” Email Retargeting” Data Distribution Queue, Lookup “Email Service B” Profile ID using BigBox Customer Email Hash as key, API format=“POST http://api.emailserviceb.com/send BODY={JSON Message}”.

In certain embodiments, for each destination, data dispatcher service 6 contacts data transformation service 8 which may execute the transformation rules and may transmit to or receive from a transformation plugin 10 API. Data transformation service 8 also may contact an ID match service 9 to lookup all needed identifications. Once all transformations and lookups are complete, data transformation service 8 may contact message queue service 11 to add the transformed including destination-scoped IDs data message to the specified message queue for the destination. Data dispatcher service 6 may also format the message according to the API specification provided by integration rules database 7.

In certain embodiments, the ID match service 9 looks up destination IDs from identifier database 4 using an identifier matching algorithm, as outlined in FIG. 3.

In certain embodiments, the message queue service 11 may place the fully formatted data message into an in-memory queue within a virtual machine and may manage the persistence of queued messages to disk as memory is exhausted.

In certain embodiments, data distribution service 12 may read messages from message queue service 11, may construct the API request, and may initiate an Internet 105 connection to integrated service 13 to deliver the message. If a success response code is received, the message is deleted from memory and the next message from the queue is read. If an error response is received, the message is added back to message queue service 11 to be retried. In some embodiments, the data distribution service 12 may include an originating server, in that, data is sent from this server as shown in FIG. 1. Also, in some embodiments, the integrated service 13 may include a destination server, in that, data is received by this server as shown in FIG. 1.

FIG. 2 illustrates, as mentioned above, a multiparty identifier synchronization process flow chart 200 according to certain embodiments. In one embodiment the identity sync service 3 may send a sync request to identifier database 4 or ID match service 9 by proceeding through the multiparty identifier synchronization module configured to perform process of flow chart 200 shown in FIG. 2 when, for example, synchronizing a first-party record and a third-party record. In one example, the method of FIG. 2 may include an identity sync request, at 205, be sent to identifier database 4 or ID match service 9. The first-party record may include a first-party sync ID or first-party identifier. In some embodiments, first-party refers to identifiers and data that are created on systems which the delivery channel owner controls. In comparison, the third-party record may include a third-party sync ID or third-party identifier. In some embodiments, third-party refers to identifiers and data that are created on systems which the delivery channel owner does not control.

The method of FIG. 2 may also include, at 210, checking whether there is an existing record of a third-party sync ID. If there is no record of a third-party sync ID, the method may, at 215, check whether there is an existing record of a first-party sync ID. If there is no record of a first-party sync ID, then the method, at 220, creates a new first-party/third-party sync ID record and, at 255, sends a sync response to identifier database 4. If there is an existing record of a first-party sync ID, then, at 225, the method may add a third-party to the first-party sync record and, at 255, send a sync response to identifier database 4.

In FIG. 2 at 230, when there is an existing record of a third-party sync ID, the method may check whether the third-party sync ID record matches the first-party sync ID. If this is the case, then, at 250, nothing is modified and the method, at 255, sends a sync response to identifier database 4. However, when the existing record of the third-party sync ID does not match the first-party sync ID, the method may again check, at 235, whether there is an existing record for first-party sync ID. If there is an existing record for first-party sync ID, at 245, the method may merge the third-party sync ID and the first-party sync ID and, at 255, send a sync response to identifier database 4. If there is no existing record for first-party sync ID, at 240, the method may add a first-party sync ID to third-party sync record and, at 255, send a sync response to identifier database 4.

FIG. 3 illustrates, as mentioned above, an identifier matching process flow chart 300 according to certain embodiments. In one embodiment, data listener service 5 may send a request, at 305, to the ID match service 9 to look up destination IDs from identifier database 4 using an identifier matching module configured to perform the process of flow chart 300 as shown in FIG. 3. In some embodiments, the identifier matching module may include the identifier sync service 3, the identifier database 4 and the ID match service 9.

The method of FIG. 3 may include, at 310, checking whether one or more IDs are needed for integrated service. If one or more IDs are not needed then, at 395, the method may send a client response to ID match service 9. If one or more IDs are needed, then, at 315, the method may check whether the data listener request, at 305, has a third-party sync ID. If no third-party sync ID is present, then the method may check, at 320, whether the data listener request, at 305, has a first-party sync ID. If no first-party sync ID is present, then the method may generate, at 325, both a third-party and a first-party sync ID and add the same to the response. Next, at 330, the method may add client-fire calls to the response then, at 395, the method may send a client response to ID match service 9. If the first-party sync ID is present, then the method may add, at 335, third-party sync ID that matches first-party sync ID to the response. If the third-party sync ID is present, then the method may check, at 340, whether the request has a first-party sync ID. If there is no first-party sync ID present, then the method may add, at 345, a first-party sync ID the references the third-party sync ID to the response. If there is a first-party sync ID present, then the method may check, at 350, whether the first-party and third-party sync IDs match. If the IDs do not match, then the method may alias, at 355, first-party sync ID to third-party sync ID in the identifier database 4. Next, the method may modify, at 360, first-party sync ID to reference third-party sync ID.

The method of FIG. 3, after steps 335, 345 and/or 360 are implemented, may find, at 365, a first integration. The method may also check, at 370, whether a vendor ID sync is present. If the vendor ID sync is present, then the method may initiate, at 385, data distribution call 12 to integrated service 13, as shown in FIG. 1. Next, the method may also check, at 390, if there is another integration server-side. If another integration server-side is not present, then the method may send, at 395, a client response to ID match service 9. If another integration server-side is present, then the method may proceed, at 375, to the next integration. If the vendor ID is not present, then the method may add, at 380, a sync and client-fire code to the response and proceed to step 390 as described above.

FIG. 4 illustrates a block diagram of a system according to certain embodiments. In one embodiment, a system may comprise several devices, such as, for example, an Internet-connected device 400 and a data center virtual local area network (VLAN) 450. Internet-connected device 400 may correspond to Internet-connected device 110, as shown in FIG. 1. The system may comprise more than one Internet-connected device or data center VLAN, although only one of each is shown for the purposes of illustration. The Internet-connected device 400 may be a web browser, native applications running on a computer or mobile device, embedded applications within devices such as point-of-sale systems, televisions/set-top boxes, gaming consoles, appliances, vehicle informatics, network routing equipment, etc. The data center VLAN 450 may be not only a local area network (LAN) but may also be a wide area network (WAN), WiFi, or a network element, such as an evolved Node B (eNB) configuration.

Each of the devices in the system may comprise at least one processor, respectively indicated as 420 and 470. At least one memory may be provided in each device, and indicated as 430 and 480, respectively. The memory may comprise computer program instructions or computer code contained therein. One or more transceiver 410 and 460 may be provided, and each device may also comprise an antenna, respectively illustrated as 440 and 490. Although only one antenna each is shown, many antennas and multiple antenna elements may be provided to each of the devices. Other configurations of these devices, for example, may be provided. For example, Internet-connected device 400 and data center VLAN 450 may be additionally or solely configured for wired communication and in such a case antennas 440 and 490 may illustrate any form of communication hardware, without being limited to merely an antenna.

Transceivers 410 and 460 may each, independently, be a transmitter, a receiver, or both a transmitter and a receiver, or a unit or device that may be configured both for transmission and reception.

Processors 420 and 470 may be embodied by any computational or data processing device, such as a central processing unit (CPU), application specific integrated circuit (ASIC), or comparable device. The processors may be implemented as a single controller, or a plurality of controllers or processors.

Memories 430 and 480 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and may be processed by the processors may be any suitable form of computer program code, for example, a compiled or interpreted computer program written in any suitable programming language.

The memory and the computer program instructions may be configured, with the processor for the particular device, to cause a hardware apparatus such as Internet-connected device 400 and data center virtual LAN 450, to perform any of the processes described above (see, for example, FIG. 1). Therefore, in certain embodiments, a non-transitory computer-readable medium may be encoded with computer instructions that, when executed in hardware, may perform a process, such as one of the processes described herein. Alternatively, certain embodiments of the invention may be performed entirely in hardware.

In certain embodiments a method for real-time data matching and integration is described. For example, the method may include collecting data in any channel without relying on tags, matching cross-device user profiles and cookies instantly in the cloud, synchronizing data in real-time or near real-time via server-to-server direct messaging, and communicating with partners to create a unique integrated service. In some embodiments, near real-time transactions may occur, for example, less than a minute, less than thirty seconds, less than 10 seconds, or less than 5 seconds. Server-to-server direct messaging may be described in some embodiments as transmitting necessary data from websites to vendor partners' websites without the use of vendor tags, and thereby without placing unnecessary load on clients' browsers. Thereby enabling the ability to collect and share data without tags enables clients to collect data where tags do not exist. Integrated service may be described in some embodiments as consistent brand messaging across both traditional and non-traditional marketing channels and using different promotional methods to reinforce each other.

In other embodiments an apparatus for real-time data matching and integration is described. For example, the apparatus may include at least one processor and at least one memory including computer program code. The at least one memory and the computer program code may be configured to, with the at least one processor, cause the apparatus at least to collect data in any channel without relying on tags, match cross-device user profiles and cookies instantly in the cloud, synchronize data in real-time with server-to-server direct messaging, and communicate with partners to create a unique open marketing stack.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1. A method for data matching and integration, the method comprising:
receiving data from a plurality of delivery channels;
followed by matching cross-device user identifiers and profiles in near real-time; and followed by
synchronizing the received data in near real-time via server-to-server direct messaging to a plurality of integrated services.

2. The method of claim 1, wherein the receiving data is performed using a data receiver application programming interface (API).

3. The method of claim 1, wherein the plurality of delivery channels comprises any of the following:
marketing channels which include at least one of broadcast media, direct mail, email, web media, mobile media, out-of-home media, and point-of-sale media; and
purchasing channels which include at least one of brick-and-mortar store sales, catalog and call center sales, Internet sales, and mobile device sales.

4. The method of claim 1, wherein the matching is performed using an ID match service configured to look up destination IDs from an identifier database via identifier matching module.

5. The method of claim 4, wherein the identifier matching module is configured to analyze, generate, modify, add, or integrate first and third-party sync IDs and send an output response to the ID match service.

6. The method of claim 1, wherein the cross-device user profiles comprise profiles provided from at least one of web browsers, native applications running on desktop computers or mobile phones/tablets, embedded applications within devices such as Point-of-Sale systems, televisions/set-top boxes/gaming consoles, appliances, vehicle informatics, and network routing equipment.

7. The method of claim 1, wherein the synchronizing is performed using an identifier sync service for identifier synchronization, the identifier sync service being configured to create or modify a record in an identifier database via multiparty identifier synchronization module.

8. The method of claim 7, wherein the multiparty identifier synchronization module is configured to create or modify a record in the identifier database by analyzing, creating, adding, or merging records for first and third-party sync IDs and send an output sync response to the identifier database.

9. The method of claim 1, wherein the server-to-server direct messaging comprises transmitting data from at least one originating server to at least one destination server.

10. An apparatus for data matching and integration, the apparatus comprising:
at least one processor; and
at least one memory including computer program code, wherein the at least one memory and the computer program code are configured to, with the at least one processor, cause the apparatus at least to
receive data from a plurality of delivery channels;
then match cross-device user identifiers and profiles in near real-time; and
then synchronize the received data in near real-time via server-to-server direct messaging to a plurality of integrated services.

11. The apparatus of claim 10, wherein the received data is received via a data receiver application programming interface (API).

12. The apparatus of claim 10, wherein the plurality of delivery channels comprises any one of the following:
marketing channels which include at least one of broadcast media, direct mail, email, web media, mobile media, out-of-home media, and point-of-sale media; and
purchasing channels which include at least one of brick-and-mortar store sales, catalog and call center sales, Internet sales, and mobile device sales.

13. The apparatus of claim 10, wherein the match comprises an ID match service configured to look up destination IDs from an identifier database via identifier matching module.

14. The apparatus of claim 13, wherein the identifier matching module is configured to analyze, generate, modify, add, or integrate first and third-party sync IDs and send an output response to the ID match service.

15. The apparatus of claim 10, wherein the cross-device user profiles comprise profiles provided from at least one of web browsers, native applications running on desktop computers or mobile phones/tablets, embedded applications within devices such as Point-of-Sale systems, televisions/set-top boxes/gaming consoles, appliances, vehicle informatics, and network routing equipment.

16. The apparatus of claim 10, wherein the synchronization comprises an identifier sync service for identifier synchronization, the identifier sync service being configured to create or modify a record in an identifier database via multiparty identifier synchronization module.

17. The apparatus of claim 16, wherein the multiparty identifier synchronization module is configured to create or modify a record in the identifier database by analyzing, creating, adding, or merging records for first and third-party sync IDs and send an output sync response to the identifier database.

18. The apparatus of claim 10, wherein the server-to-server direct messaging comprises transmitting data from at least one originating server to at least one destination server.

19. A system for data matching and integration, the system comprising:
at least one Internet-connected device;
at least one virtual local area network (VLAN); and
the apparatus of claim 10, wherein the at least one memory and the computer program code are configured to, with the at least one processor, cause the apparatus at least to
receive data, via the VLAN, from a plurality of delivery channels;
then match, via the VLAN, cross-device user identifiers and profiles in near real-time; and
then synchronize, via the VLAN, the received data in near real-time via server-to-server direct messaging to a plurality of integrated services.

20. A computer program product storing a program comprising software code portions being configured, when run on a processor, to perform the method according to claim 1.
